(19) United States
(12) Patent Application Publication
(10) Pub. No.: US 2025/0021911 A1
(43) Pub. Date: Jan. 16, 2025

(54) GLOBAL SUPPLY CHAIN MANAGEMENT

(71) Applicant: HONEYWELL INTERNATIONAL INC., Charlotte, NC (US)

(72) Inventors: Anish Chakrabarti, Cincinnati, OH (US); Krishna Pillutla, Marietta, GA (US)

(21) Appl. No.: 18/221,389

(22) Filed: Jul. 13, 2023

(51) Int. Cl. G06Q 10/0639

(52) U.S. Cl. CPC G06Q 10/06393

(57) ABSTRACT

Techniques for global supply chain management are described. In one aspect, a performance metric from each facility from amongst a plurality of facilities is obtained, where the plurality of facilities form a part of a global supply chain, where the performance metric is indicative of key performance indicators corresponding to each facility determined based on a set of parameters associated with an integrated database of each facility. Accordingly, the performance metric obtained from each facility is integrated to generate a first integrated analytical output. The first integrated analytical output is analyzed to generate a first global performance metric, where the global performance metric corresponds to the global supply chain. The global performance metric is provided to a user for managing the global supply chain, and an actionable event is received from the user for a facility from amongst the plurality of facilities.

### TECHNICAL FIELD

The present subject matter relates, in general, to supply chain management, and in particular, to managing a global supply chain network.

### BACKGROUND

Managing and monitoring of a supply chain and the processes associated with the supply chain, is done to ensure that the supply chain works in an efficient manner. From sourcing to dispatch, there are multiple processes interrelated with one another which are to be monitored, analyzed, and assessed, so that the performance of the supply chain remains at its best. To manage and monitor the functioning of the supply chain, at a local level, limited to a single facility of the supply chain, or at a global level, involving multiple facilities of the entire supply chain, personnel from different layers of a hierarchical structure are involved. These personnel interact with one another to ensure that the operations of the supply chain network meet the set standards.

### SUMMARY

Aspects of the present subject matter provide techniques for managing a supply chain network at a global level to facilitate improved performance of the supply chain network globally.

According to an example of the present subject matter, a method for global supply chain management is provided. The method includes, obtaining a performance metric from each facility from amongst a plurality of facilities, where the plurality of facilities form a part of a global supply chain, where the performance metric is indicative of key performance indicators corresponding to each facility determined based on a set of parameters associated with an integrated database of each facility, integrating the performance metric obtained from each facility to generate a first integrated analytical output, analyzing the first integrated analytical output to generate a first global performance metric, wherein the first global performance metric corresponds to the global supply chain, providing the first global performance metric to a user for managing the global supply chain, and receiving an actionable event from the user for a facility from amongst the plurality of facilities.

According to another example of the present subject matter, a system for global supply chain management is provided. The system includes an input module, an integrating module, an analyzing module, and an output module. The input module is to obtain a performance metric from each facility from amongst a plurality of facilities, where the plurality of facilities form a part of a global supply chain, where the performance metric is indicative of key performance indicators corresponding to each facility determined based on a set of parameters associated with an integrated database of each facility. The integrating module is to integrate the performance metric obtained from each facility to generate a first integrated analytical output. The analyzing module is to analyze the first integrated analytical output to generate a first global performance metric, wherein the first global performance metric corresponds to the global supply chain, and the output module is to provide the first global performance metric to a user for monitoring the global supply chain and identifying one or more actionable events: and in response to identifying one or more actionable events, receive a direction based on the identified one or more actionable events.

According to another example of the present subject matter, a non-transitory computer readable medium containing program instruction is provided, that, when executed, causes the processor to obtain a set of parameters from each database of an integrated database associated to each facility from amongst a plurality of facilities, where the plurality of facilities form a part of a global supply chain, determine key performance indicators corresponding to each facility based on the set of parameters, generate a performance metric for each facility, where the performance metric is indicative of the key performance indicators, integrate the performance metric obtained from each facility to generate an integrated analytical output, analyze the integrated analytical output to generate a global performance metric, where the global performance metric corresponds to the global supply chain, provide the global performance metric to a user for managing the global supply chain, and receive an actionable event from the user for a facility from amongst the plurality of facilities.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a global supply chain network environment, in accordance with an example implementation of the present subject matter.

FIG. 2 illustrates an example global supply chain network, in accordance with an example implementation of the present subject matter.

FIG. 3 illustrates another example of the global supply chain network, in accordance with an example implementation of the present subject matter

FIG. 4 illustrates a global supply chain management system, in accordance with an example implementation of the present subject matter.

FIG. 5 illustrates an example of a work being issued, in accordance with an example implementation of the present subject matter.

FIG. 6 illustrates an example method for global supply chain management, in accordance with an example implementation of the present subject matter.

FIG. 7 illustrates another example method for global supply chain management, in accordance with an example implementation of the present subject matter.

FIG. 8 illustrates an example of a global supply chain management scenario corresponding to monitoring energy sustainability, in accordance with an example implementation of the present subject matter.

FIG. 9 illustrates a non-transitory computer-readable medium for global supply chain management, in accordance with an example implementation of the present subject matter.

### DETAILED DESCRIPTION

The present subject matter relates to techniques for managing a supply chain network at a global level. Generally, management systems employed for performance monitoring in a facility, monitor and analyze operations associated with the transactions of the concerned facility. In one example, a facility may relate to supply chain, hospital management, Fast-moving Consumer Goods, and the like. For the ease of understanding, the following description has been explained with reference to the facility relating to a supply chain. The management systems employed at various facilities collect and analyze data from various systems involved in the operation of the supply chain facility, such as inventory management systems, warehouse management systems, asset management systems, human resources management system, and the like. Typically, different managers, such as facility operation managers or facility maintenance managers monitor these management systems to recognize any abnormalities or issues in the operation of the supply chain facility. On identification of an abnormality or an issue associated with any operation of the supply chain facility, a direction may be issued to respective personnel of the supply chain facility for resolution. By restoring and managing the issues that occur, or by preempting them based on the analysis obtained from the management systems, the performance of the supply chain facility is unaffected. However, these management systems are limited to the operational information associated with the concerned facility alone.

To ensure high performance across the whole supply chain network at a global level, for example, on considering an enterprise with about a hundred facilities, operational information associated with all facilities are to be monitored, analyzed, and assessed. Personnel from various levels of a hierarchical structure of an enterprise may analyze operational data of all facilities that form a part of the supply chain network in order to take informed decisions. Particularly, for decision making at a global level, by personnel positioned higher up in the hierarchical structure, for example, c-suite executives, understanding the challenges faced at various facilities of the supply chain becomes important. Not only understanding the challenges, but also how facilities of the supply chain perform in comparison to one another becomes essential. For example, some decisions related to where to invest next, why a particular facility is under-performing when compared to another facility and what changes in the structure could bring about a change in the under-performing facility, whether the right people are working on the right jobs, whether a network wide training initiative is to be conducted, whether outsourcing of maintenance teams is required, and the like. Such decisions are currently taken through various meetings and discussions with managers and facility heads where data is manually collected and presented. This is time consuming and prone to errors. Moreover, lacks real-time visibility.

In an organization involving hundreds of such facilities located at different geographical locations, globally, obtaining, integrating, and monitoring the data to be presented globally is challenging. For example, each facility of the global supply chain may track and update data onto their management systems using different methods and formats. For example, one facility of the global supply chain may monitor data using fairly obsolete platforms, whereas another facility of the same global supply chain may monitor data through an advanced platform. Similarly, the management system of one facility may collect and analyze one set of performance parameters to generate a performance report, whereas the management system of another facility may collect and analyze a different set of parameters to generate the performance report. Therefore, to facilitate decision making at a global level, collation, and integration of data from various facilities of an exceptionally large supply chain network would be necessary.

Typically, if a personnel involved in the decision-making process wishes to monitor or manage a particular facility of the supply chain, the personnel may have to reach out to the managers of the facility in question and then take manual updates. This is a time consuming, and a cumbersome process. Even on considering a scenario where the data may be made visible at a global level, personnel involved in the decision-making process need to access the management system associated with that particular facility to issue a direction to a personnel of the facility, and also may have to go through a hierarchical structure of personnel to have an action executed. For example, the decision making personnel may also be provided with an access to the management systems associated to each facility, for example, a local Computerized Maintenance Management System (CMMS) of that particular facility to monitor the events specific to that facility and accordingly issue directions for completion of work or task and the like. The CMMS of the facilities may differ from each other, for example, the type of CMMS, the facility is using, the version of the CMMS, the interfacing fields configured for monitoring, and the like. So, when the decision-making personnel has to monitor and issue a direction, for example, in facility ‘A’ and facility ‘B’, the personnel may have to access the CMMS associated with facility ‘A’ and separately access the CMMS associated with facility ‘B’ to issue a direction to a personnel of facility ‘A’ and facility ‘B’, respectively. When this process has to be followed in large enterprises, it is inconvenient and may be extremely challenging to manage the whole supply chain network.

Also, monitoring of the action being executed can be further challenging. For example, if a chief maintenance manager of the global supply chain, wishes to check on a direction issued to one or more facilities, the direction would pass through multiple layers of personnel of the hierarchical structure, until the direction is finally issued to the personnel working on the floor. Alternatively, the chief maintenance manager may need to access different CMMS of the one or more facilities to monitor the action being executed. This whole communication chain and access to a variety of CMMS is time-consuming as well as opens up chances for miscommunication or may be prone to errors. A similar approach would be followed frequently to check upon a status of the direction issued, which would cascade the amount of time involved in receiving an update, and the like.

Accordingly, to overcome these and other challenges, the present subject matter provides techniques to monitor, assess, and manage performance metrics of the entire supply chain of an organization at a global level. In operation, a performance metric from each facility from amongst a plurality of facilities which form a part of the global supply chain is obtained. The performance metric of each facility indicates the key performance indicators that are associated with the concerned facility. In one example, the key performance indicators corresponding to each facility are determined based on a set of parameters associated with the concerned facility. For example, each facility may include an integrated database that includes data from the multiple sub-systems associated with the concerned facility which relate to an asset management system, a human resource management system, a workforce intelligence management system, a labour management system, inventory management system, and the like. Based on a set of parameters obtained from these sub-systems, the key performance indicators are determined, and the key performance indicators are depicted on the performance metric.

The performance metrics obtained from each facility from amongst the plurality of facilities are integrated to generate a first integrated analytical output. The first integrated analytical output is analyzed to generate a first global performance metric, where the first global performance metrics corresponds to the global supply chain. The first global performance metric may then be provided to a user for managing the global supply chain. The user may monitor the first global performance metric which not only provides an analysis of the operations of various facilities individually, but also provides a comparison between the operations of the plurality of facilities of the global supply chain network. Further, in response to providing the first global performance metric to the user, the user may identify an actionable event for a facility from amongst the plurality of facilities. On receiving an actionable event for a facility from amongst the plurality of facilities from a user, a direction is issued to the concerned facility. In one example, the direction may be transformed to a format compatible with the management system utilized by the facility and a status of the direction issued may also be monitored. In one example, the direction is issued to a personnel associated with the direction for a concerned facility.

Therefore, as users associated with the decision-making process can not only view all key performance indicators of each site of the supply chain comprehensively, but can also issue actionable events, for example, work orders, to personnel at different layers of the hierarchical structure of the organization in a centralized manner, techniques of the present subject matter enhance the performance of the supply chain globally. Further, techniques of the present subject matter eliminate the process of having to access management systems of each facility separately for managing the facility from a global level. Furthermore, as techniques of the present subject matter facilitate an interaction between the user and a personnel to whom the actionable event is issued, chances of miscommunication is minimized, and an impact of the actionable event being executed can be monitored, based on which the global performance metrics may be reanalyzed for further action.

The above and other features, aspects, and advantages of the subject matter will be better explained with regards to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

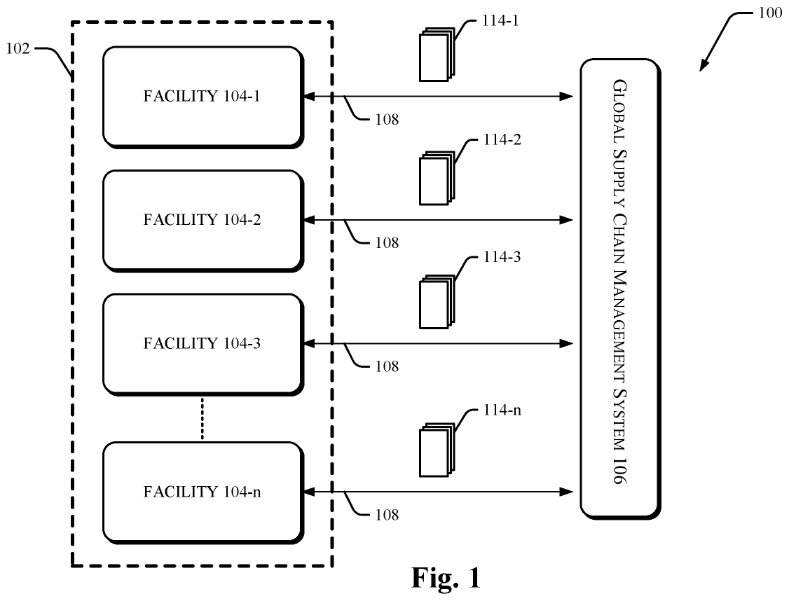

FIG. 1 illustrates a global supply chain network environment 100, in accordance with an example implementation of the present subject matter. In one example, the global supply chain network environment 100 may include a supply chain network 102 including a plurality of facilities, 104-1, 104-2, 104-3, . . . 104-n, collectively and alternatively referred to as plurality of facilities 104 or facility 104. For example, but not limited to, the facility may be a warehouse in a packaging industry, an assembling unit of an automobile manufacturing company, a consumer-goods manufacturing unit, an e-commerce storage unit, cold storages of a food manufacturing company, a pharmaceutical manufacturing unit, a distributer of a logistics company, and the like. In one example, the plurality of facilities 104 may be distributed at various geographical locations, across the globe. Each of the plurality of facilitates 104 may include a facility management system (not shown in the figure). In one example, the facility management system associated with one facility of the plurality of facilities 104 may be different from the facility management system associated with another facility of the plurality of facilities 104. The facility management system may be employed in each facility for performance monitoring. In one example, the facility management system may be part of a source device (not shown in the figure), where the source device may be an Internet of things (IoT) device, a computing device, a personal computer, a laptop, a tablet, a mobile phone, and the like. In another example, the facility management system may be hosted on a server (not shown in the figure) that may communicate with the source device.

In one example, the facility management system of each of the plurality of facilities 104 may be communicatively coupled to a global supply chain management system 106. In one example, the facility management systems and the global supply chain management system 106 may communicate over a network 108. The network 108 may be a wireless network or a combination of a wired and wireless network. The network 108 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers: however, such details have been omitted to maintain the brevity of the description.

Further, the global supply chain management system 106 may be implemented in any computing system, such as a storage array, server, desktop or a laptop, computing device, a distributed computing system, or the like. Although not depicted, the global supply chain management system 106 may include other components, such as interfaces to communicate over the network or with external storage or computing devices, display, input/output interfaces, operating systems, applications, data, and other software or hardware components (all of which have not been depicted for brevity).

In one example, the global supply chain management system 106 may obtain a plurality of performance metric 114-1, 114-2, 114-3, . . . , 114-n, collectively referred to as performance metrics 114, from the plurality of facilities 104-1, 104-2, 104-3, . . . 104-n, respectively. In one example, the performance metrics 114 generated by the plurality of facilities 104 may be indicative of key performance indicators corresponding to each facility. For example, in a warehouse facility, the performance metric would indicate the throughput of the facility, worker's idle time, productivity, functioning of the assets, total number of tasks completed, number of tasks that are currently active, performance on a daily, quarterly, and yearly basis, and the like. The key performance indicators may be determined based on a set of parameters corresponding to each of the facilities 104. Referring to the example of a warehouse facility, the set of parameters may be, for example, total number of workers present in the facility, the number of assets that are under maintenance, inventory stock, number of personnel currently working on a particular shipment, the time taken for a shipment to leave the warehouse, the time taken between an order being placed and the order being shipped, and the like. Each of the facilities from amongst the plurality of facilities 104 may obtain such parameters associated with the respective facility to determine the corresponding performance metric 114.

On obtaining the performance metric 114 from each of the facilities 104 of the supply chain network 102, the global supply chain management system 106 may integrate the obtained performance metrics 114. Further, on integrating the performance metrics 114 obtained from the plurality of facilities 104, the integrated data may then be analyzed to determine a global performance metric. In an example of the supply chain network including a plurality of warehouse units, the global performance metrics may include an analysis of how one warehouse unit of the supply chain is performing in comparison to another warehouse unit of the supply chain, historical data of every warehouse unit of the supply chain, throughput of various warehouse units, performance efficiency, energy consumption, and the like.

The global performance metric (not shown in the figure) may be further presented to a user for managing the global supply chain network 100. In one example, the global performance metric may be provided to a group of users who form the highest layer of the hierarchical structure of an organization. The group of users who form the highest layer of the hierarchical structure of an organization may be involved in the decision-making process for the supply chain network, at a global level. For example, directors of various departments, chief executives, and the like. This will facilitate the decision-making process as the users from the highest layer of the hierarchical structure of an organization will be able to monitor how various warehouse units, for example, are performing comparatively amongst one another. In one example, based on the global performance metrics, the user may be able to issue an actionable event to one or more facilities of the supply chain network, where an actionable event may be issuing a notification, assigning a work order, re-allocating a manufacturing order, and the like. In another example, the global performance metric may be presented to personnel from various layers of the hierarchical structure of the organization, in addition to the users who form the highest layer of the hierarchical structure. In response to presenting the global performance metric to the user, the global supply chain management system 106 may receive inputs from the user to issue directions to one or more facilities of the supply chain network 102.

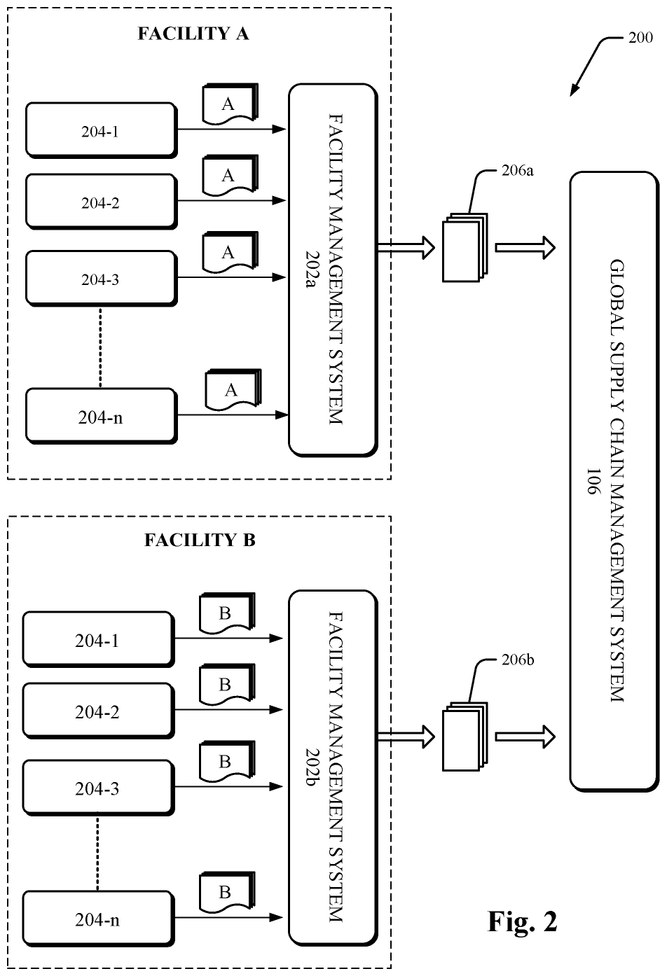

FIG. 2 illustrates an example global supply chain network 200, in accordance with an example implementation of the present subject matter. In one example, the global supply chain network 200 depicts facility A and facility B communicatively coupled to the global supply chain system 106. For the sake of simplicity, the following description has been predominantly discussed with reference to facility A and facility B of the supply chain network, communicatively coupled to the global supply chain management system 106. However, similar principles may be applicable to all facilities of a supply chain network coupled to the global supply chain management system 106.

In one example, the facility A of the global supply chain network 200 may be located in a first geographical location and the facility B of the global supply chain network 200 may be located at a second geographical location. Each of the facilities, the facility A and the facility B, may include a facility management system 202a, 202b, respectively. In one example, the facility management system 202a of facility A and the facility management system 202b of facility B may be communicatively coupled to the global supply chain management system 106.

Further, facility A and facility B of the supply chain network may include a plurality of sub-systems 204-1, 204-2, 204-3, . . . 204-n, collectively and alternatively referred to as sub-systems 204, associated with the various operations of the facility, respectively. In one example, the sub-systems 204 of the facility may be broadly categorized into assets, processes, and personnel. For example, but not limited to, the sub-systems 204 of the various categories, collectively, may include control systems, warehouse execution systems, inventory management, asset performance management systems, yard management systems, energy management systems, labour management systems, human resource management systems, and the like. In one example, the sub-systems may be sensors or actuators from which data may be collected through different means. In another example, the sub-systems may be part of a source device (not shown in the figure), where the source device may be an Internet of things (IoT) device, a computing device, a personal computer, a laptop, a tablet, a mobile phone, and the like. In yet another example, the sub-system may be hosted on a server (not shown in the figure) that may communicate with the source device. Data A and data B from each of these sub-systems 204 may be collected by the facility management systems 202a and 202b, respectively.

For example, the facility management system 202a may collect data A from all the sub-systems 204 associated with facility A. In one example, the facility management system 202a may be communicatively coupled to the sub-systems 204 of the facility A. In one example, each of these sub-systems 204 may be integral to the facility management system 202a. In another example, each of these sub-systems 204 may be external to the facility management system 202a.

The facility management system 202a may collect and store data A from each of these sub-systems 204 associated with facility A. For example, but not limited to, data associated with assets of the facility A may include information regarding the performance of an asset in the facility, measurement data collected from the asset, such as temperature levels, voltage measurements, current measurements, loading, etc., calibration details of the asset, energy consumption of different assets utilized in the facility, and the like. Further, data A associated with processes that take place in facility A may include, for example, time taken to complete a process, idle time of personnel working on the process, a percentage of completion of the targets set for the day, goals to be achieved for a day, quarter, or year, and the like. Similarly, data A associated with personnel of facility A, may include information regarding every personnel working in the facility, which personnel is assigned with which work, how many people have been assigned for a task, for example, shipping, number of personnel working on the floor, shift details of various personnel working in facility A, information regarding a leave status of various personnel, performance ratings of a personnel, personal data, and the like.

In one example, the facility management system 202a of facility A may integrate all the data A collected from sub-systems 204 into an integrated database (not shown in the figure) of the facility management system 202a. Further, data from the integrated database of the facility management system 202a may be analyzed to determine a performance metric 206a of facility A. In one example, a quality check may be performed on the analyzed data in order to determine the performance metric 206a. In one example, based on the performance metric 206a, a performance of the facility A may be ascertained. For example, a shift manager or a facility manager of facility A may monitor the performance metric 206a to determine if an asset of the facility has been maintained well or if maintenance is required, assets that may require maintenance, if the targets set for the day have been met, if the tasks are being completed efficiently, and the like. Further, the performance metric 206a of facility A may be communicated to the global supply chain management system 106 for further analysis with respect to the global supply chain network.

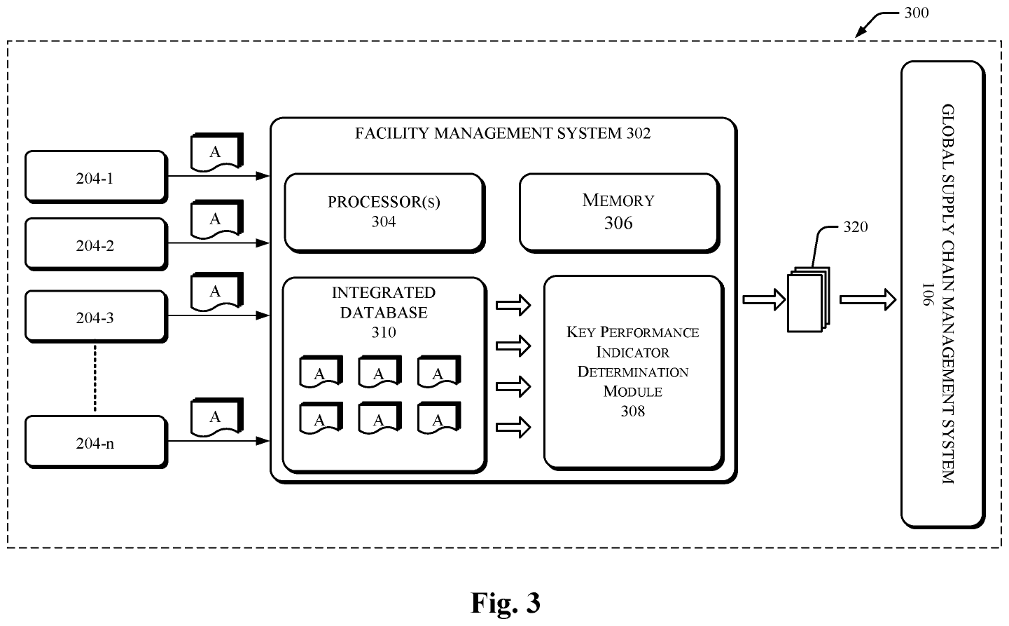

Similarly, data B from the plurality of sub-systems 204 associated with facility B of the supply chain network may be collected and stored in the facility management system 202b. Based on the data B collected, the facility management system 202b may determine a performance metric 206b which may be communicated to the global supply chain management system 106. The global supply chain management system 106 may integrate the data collected from facility A and facility B to further analyze the data, in order to determine a global performance metric. The determination of the performance metric by the facility management system has been discussed with reference to FIG. 3.

FIG. 3 illustrates an example supply chain network 300, in accordance with an example implementation of the present subject matter. Although the following description has been described with reference to a single facility of the supply chain network, it may be understood that similar principles may be applicable to all other facilities of the supply chain network. In one example, the facility management system 302 includes a processor 304 and a memory 306. The processor(s) 304 may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. The memory 306 may include any computer-readable medium including, for example, volatile memory (e.g., RAM), and/or non-volatile memory (e.g., EPROM, flash memory, etc.).

The facility management system 302 may further include modules, such as a key performance indicator module 308. In one example, the key performance indicator module 308 may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module. In such examples, the global supply chain management system 106 may include the machine-readable storage medium storing the instructions and the processing resource to execute the instructions. In other examples of the present subject matter, the machine-readable storage medium may be located at a different location but accessible to the facility management system 302 and the processor(s) 304.

The facility management system 302 may further include an integrated database 310, that serves, amongst other things, as a repository for storing data that may be fetched, processed, received, or generated by the modules. The data may include data from the various sub-systems of the facility, such as performance management monitoring data, performance metrics, and the like.

In one example, the key performance indicator module 308 may obtain a set of parameters from the integrated database 310. These set of parameters may be collected from the various sub-systems 204 associated with the facility, as explained with reference to FIG. 2. Based on these set of parameters, the facility management system 302 may determine a key performance indicator. Based on the key performance indicators determined, the facility management system 302 may generate a performance metric 320. In one example, in addition to the key performance indicators, the performance metric 320 may also include data associated with the various subsystems 204 of the facility.

The following example is only to elucidate determination of key performance indicators of a facility of the supply chain network and is not to be construed as a limitation. The following example describes the key performance indicators that may be associated with a workforce of a warehouse. For example, the key performance indicators may include: total tasks, where the total tasks may be computed as the total tasks completed by the workforce: active tasks, which are the number of tasks that may be active: task summary, which may be a breakdown of total tasks in progress and blocked: average resolution time, which may be the average resolution time for tasks: task priority, which may be a breakdown of task by priority: high, medium, or low: high priority tasks based on categories, or most common tasks, which may be common tasks by: categories, creators, and assigners: task overview by location, which may be a breakdown of total tasks by location: tasks by worker, which may be a breakdown of total tasks by location, and the like.

Additionally, the key performance indicator module 308 may compute the key performance indicators such as performance percentage, on-standard percentage, effectiveness, units per hour, active workers, idle time, units lost in idle time, total cost of idle time, and the like based on the set of parameters obtained from the integrated database 310. For example, but not limited to, the set of parameters such as a performance rating of on-standard work performed based on the total goal time versus the actual time worked, the percentage of work hours that were on-standard, a performance rating that combines an individuals on-standard percent and performance percentage, the units produced per hour or productivity for the work performed, the count of on-shift workers with an active task, a difference between the total time worked and a sum of the on-standard work, off-standard work, and break time, the idle times, the cost of units, cost of worker's hours, and the like may be collected to determine the key performance indicators associated with the facility of the global supply chain network.

Based on the key performance indicators, the facility management system 302 may determine the performance metrics 320 of the facility. In one example, the performance metrics 320 of the facility may include additional data associated with the sub-systems 204 of the facility. In one example, the performance metrics 320 of the facility may be monitored by a facility manager, for example, a shift manager, to check if the production goals of the facility are being met, or if there are any issues that are hindering the production levels, and the like. The performance metrics 320 of the facility may be communicated to the global supply chain management system 106. In one example, based on the performance metrics 320 obtained from one or more facilities of the global supply chain network, the global supply chain management system 106 may determine a global performance metric where users from the highest layer of the hierarchical structure can monitor and manage the concerned facility. For example, users from the highest layer of the hierarchical structure, such as chief operations officer, or chief maintenance manager of the global supply chain can monitor and manage one or more facilities directly, based on a global performance metrics determined.

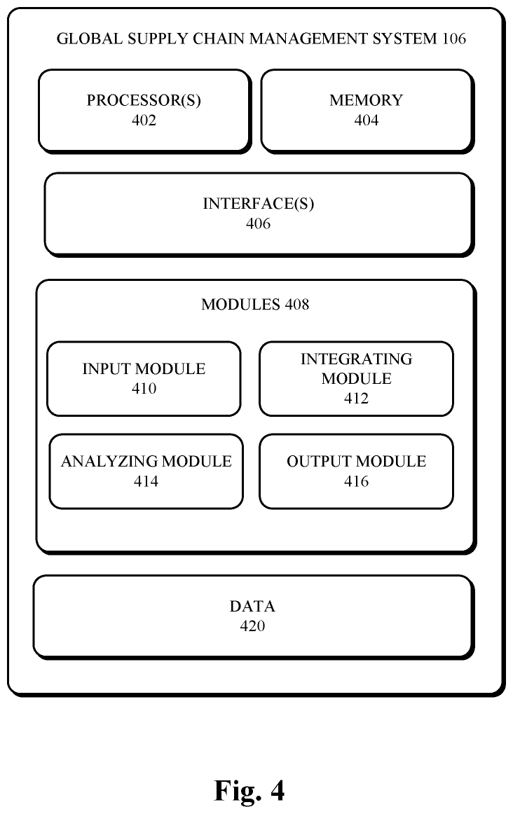

FIG. 4 illustrates a global supply chain management system 106, in accordance with an example implementation of the present subject matter. In one example, the global supply chain management system 106, alternatively referred to as system 106, may include a processor 402 and a memory 404 coupled to the processor 402. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) may allow the connection or coupling of the system 106 with one or more other devices (say devices or systems within the global supply chain network), through a wired (e.g., Local Area Network, i.e., LAN) connection or through a wireless connection (e.g., Bluetooth®, Wi-Fi). The interface(s) 406 may also enable intercommunication between different logical as well as hardware components of the system 106.

The memory 404 may include any computer-readable medium including, for example, volatile memory (e.g., RAM), and/or non-volatile memory (e.g., EPROM, flash memory, etc.).

The global supply chain management system 106 may further include modules 408, such as an input module 410, an integrating module 412, an analyzing module 414, and an output module 416. In one example, module(s) 408 may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the modules 408. In such examples, the global supply chain management system 106 may include the machine-readable storage medium storing the instructions and the processing resource to execute the instructions. In other examples of the present subject matter, the machine-readable storage medium may be located at a different location but accessible to the global supply chain management system 106 and the processor 402.

The global supply chain management system 106 may further include data 418, that serves, amongst other things, as a repository for storing data that may be fetched, processed, received, or generated by the modules 408. The data 418 may include communication data, performance management monitoring data, performance metrics, global performance metrics, and the like. In an example, the data 418 may be stored in the memory 404.

The input module 410 of the global supply chain management system 106 may obtain a performance metric from each facility from amongst a plurality of facilities. In one example, the plurality of facilities may form a part of a global supply chain network, where the plurality of facilities may be located at different geographical locations. The performance metrics obtained from the plurality of facilities may be indicative of key performance indicators corresponding to each facility. In one example, the key performance indicators corresponding to each facility may be determined based on the set of parameters associated with an integrated database of each facility as discussed with reference to FIG. 2 and FIG. 3.

On obtaining the performance metric of each of the facilities, an integrating module 412 of the system 106 may integrate the data obtained from each facility. The integrating module 412 may generate a first integrated analytical output. Based on the first integrated analytical output, the analyzing module 414 of the system 106 may generate a first global performance metric, where the first global performance metric corresponds to the global supply chain. In one example, the analyzing module 414 may perform a comparative analysis based on the performance metrics obtained from the plurality of facilities to determine the first global performance metrics. In one example, the analyzing module 414 may utilize techniques of machine learning to determine the first global performance metric. The first global performance metrics may include statistical data corresponding to the various facilities of the supply chain, historical data collected over a period of time associated with each facility of the supply chain, a summary based on the comparative analysis performed by the analyzing module 414, a recommended action, where the recommended action may be based on performing a predictive analysis on the integrated data, and the like. The first global performance metric may be monitored by a user for managing the global supply chain.

The following description elucidates examples of the first global performance metrics determined by the analyzing module 414 and is not to be construed as a limitation. In one example, the first global performance metrics may include key performance indicators at the global level, such as task performance, where task performance may include data corresponding to the total number of tasks that have been completed across the global supply chain: a number of common tasks that are being performed, a number of tasks that are active across various facilities, and the like. In addition to such statistical data provided concerning the tasks associated with the various facilities of the global supply chain network, the analyzing module 414 of the system 106 may also provide a summary of details corresponding to the tasks being performed, for example, whether all facilities have met their daily, quarterly, or yearly assigned task goals, or if one facility is lacking behind in a particular type of task, a percentage factor indicating an improvement, i.e., whether there is a steady increase in the performance levels or if there is a decline in performance in some of the facilities, and the like. The first global performance metrics may also indicate data corresponding to idle time, for example, the total idle time across the plurality of facilities, the total units lost, a financial implication of the total units lost, and the like. Similarly, the first global performance metrics may indicate data corresponding to productivity, asset performance, or workforce, where the number of active workers amongst the total number of workers across all facilities may be provided, the total number of work units completed per hour, the total number of faulted assets across the global supply chain network, the frequent fault types that our in facilities, the total number of faults repaired, an incident response time to a work order that may be issued, an average resolution time, a number of outstanding work orders, the total downtime, number of facilities that are facing down time, the number of facilities that are currently running, the facilities that are facing a power outage, and the like.

In addition to providing a comparative analysis amongst the plurality of facilities of the supply chain, statistical data, historical data, and a summary of the comparative analysis, the analyzing module 414 may provide recommended actions based on the first global performance metric that is determined. In one example, when the first global performance metric is provided to the user, the user may use the recommended action, based on which a direction may be issued to a particular facility. In another example, the user may issue a direction independent of the recommended action.

For example, recommended actions may indicate to reduce idle time in the shipping area for one of the facilities say facility located in area ‘z’, or to reallocate workers of facility ‘a’, or to improve the throughput of one of the facilities in order to boost the financials by a particular value annually, or to reduce energy consumed per carton by about 8%, for example, may result in reduction of the portfolio carbon footprint by an 10%, or to improve the maintenance on shipping sorter, which could improve the downtime by about 10%, or meeting the worker staffing needs on one facility, say facility ‘x’ may improve the productivity by about 10%, or upgrading the faulted asset of facility ‘y’ may increase the overall throughput by for example, about 20%, or increasing the worker staffing on site ‘x’ may improve the average resolution time by for example, about 5% which would meet the quarterly requirements of the portfolio, and the like.

Further, the analyzing module 414 may also filter the first global performance metrics generated, based on a request received from the user. In one example, the first global performance metric may be filtered based on a key performance indicator, a location of the facility, a time window, and the like. For example, if an asset analyst wants to monitor the global performance metrics, the asset analyst may request information that relates to the assets of different facilities, located in regions ‘x’, ‘y’, and ‘z’ for the past quarter or, the present day, and the like.

On obtaining the first global performance metrics, the output module 416 of the system 106 may provide the first global performance metrics to the user. In one example, the user may belong to the highest hierarchical layer of the global supply chain. For example, users of the highest hierarchical layer of the global supply chain may include asset analysts, sustainability directors, regional managers, production process directors, workforce directors, vice-president operations, and the like. In another example, the first global performance metrics may also be provided to the plurality of facilities, where personnel of the facilities associated to the particular facility, such as facility managers, shift managers, maintenance managers, associates, and workers may be able to access the first global performance metrics.

In one example, the user may monitor the first global performance metric and identify one or more actionable events. In one example, the one or more actionable events may be identified to optimize the key performance indicators corresponding to each facility, at a global level. For example, the one or more actionable events may be identified that may result in improving the overall productivity of the supply chain at a global level, reducing the outage time, reducing the energy consumption levels, reducing the idle time of workers, and the like. With reference to the example of the asset analyst, the asset analyst may monitor the first global performance metric and then identify one or more actionable events. For example, the asset analyst may monitor the performance of the assets across facilities x, y, and z, and may identify that by upgrading the asset in facility y, the overall productivity levels across the global supply chain may increase and may accordingly issue a direction to the global supply chain management system 106.

In one example, the user may provide an input to the global supply chain management system 106, based on the identified one or more actionable events. In one example, the one or more actionable events may be a notification, a task, or a work order. In another example, the one or more actionable events may also be reallocating an order from one facility to another facility of the supply chain based on the production capabilities or issuing a new order for manufacturing to a group of facilities, or reallocating personnel based on their expertise to improve the workflow of a particular facility, redistribute work assigned to improve the performance of the supply chain at a global level, and the like.

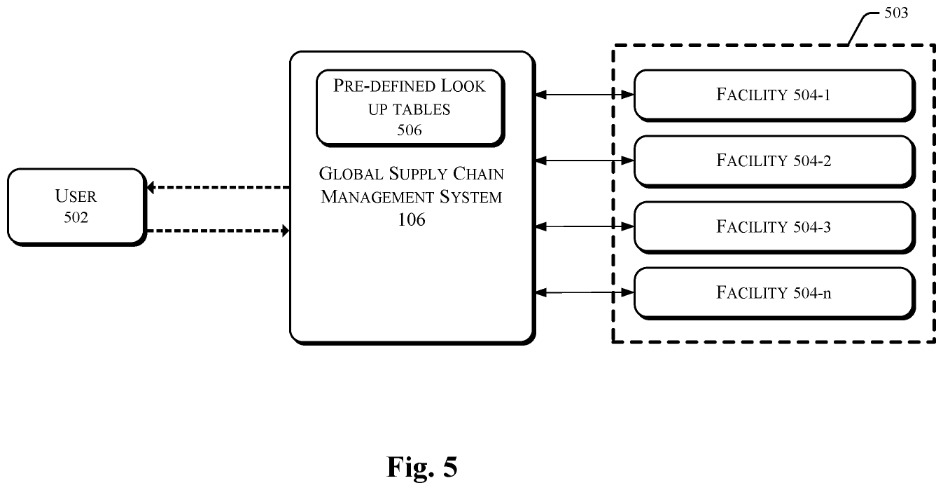

Based on the input provided by the user, the output module 416 of the global supply chain management system 106 transform the actionable event into a format compatible with the facility management system of the facility associated with the actionable event. In one example, the analyzing module 414 may extract details of facility based on the actionable event. For example, if the actionable event is for facility ‘D’, then the analyzing module 414 may determine a format that is compatible with, or information regarding the management system of facility ‘D’ to transform the actionable event to a format compatible with facility ‘D’. This process may be performed based on a pre-determined look up table utilized, where the look-up table may be searched based on a unique identifier associated to the facility to which the actionable event may be issued. Transforming the actionable event to a format compatible with the facility concerned has been discussed in reference to FIG. 5.

Further, the output module 416 of the system 106 may issue the transformed one or more actionable events to one or more personnel of one or more facilities amongst the plurality of facilities, where the one or more personnel of the one or more facilities may be associated with the one or more actionable events, respectively. For example, the asset analyst may provide an input to the global supply chain management system to issue directions to personnel A and personnel B of the facility y, where the personnel A and personnel B may be required to work on the upgradation of an asset in facility y of the supply chain. In one example, the direction may be issued through a work order. Where, the work order may be transformed to be compatible with the facility management system of facility ‘y’, and then be issued to personnel A and personnel B of facility ‘y’ by the asset analyst of the global supply chain. In another example, the work order may be directly issued to personnel A and personnel B of facility ‘y’ and a maintenance manager of facility ‘y’ by the asset analyst of the global supply chain, where the maintenance manager is to supervise the work being executed by personnel A and personnel B, and the like.

Further, in one example, a status update on the one or more actionable events from the one or more personnel of the one or more facilities amongst the plurality of facilities, may be input to the global supply chain management system 106. On receiving a status update on the one or more actionable events from the one or more personnel of the one or more facilities, the analyzing module 414 may reanalyze the integrated data to generate a second integrated analytical output to generate a second global performance metrics based on a status update received. Accordingly, the user can monitor the second global performance metrics to plan a future course of action. In one example, the user of the highest layer of the hierarchical structure may be able to monitor an effect of the one or more actionable events issued in near real-time. In one example, based on the status update the user may decide to either issue another work order if the identified issue still persists, or may issue an order for reallocation to another facility of the supply chain, and the like, so that the overall performance of the supply chain at a global level remains at its best.

An example to elucidate the monitoring and management of the global supply chain associated with the global supply chain management system 106 is described, not to be construed as a limitation. An enterprise with two facilities, where the facility is a warehouse is described. Where, warehouse A of the enterprise may be located in a first location and warehouse B of the enterprise may be located at a second location. Each of these warehouses, i.e., warehouse A and warehouse B may have a shipping order to be completed, where each warehouse may have to ship around 10,000 units for example. Based on the performance metric obtained from warehouse A and warehouse B of the enterprise, the global supply chain management system may generate the first global performance metric. The first global performance metric may be provided to a user, for example, the director of the enterprise for monitoring the first global performance metric. In one example, the director may identify that the warehouse A seems to be lagging behind warehouse B by a huge margin and may identify an issue as to why warehouse A may be underdelivering. In one example, from the first global performance metric, the director may identify that an asset of warehouse A, for example, a conveyor belt is jammed or not working. Based on the data provided by the first global performance metric, the director may be able to check the personnel available at warehouse A, capabilities of the various personnel working at warehouse A, shift timings of different personnel available in warehouse A at the moment, and the like. Based on this information, the director may send an input to the global supply chain management system, directing the global supply chain management system to issue an actionable event to a personnel ‘X’ for example, of the warehouse A. In one example, the actionable event may be a task for personnel ‘X’, where the personnel ‘X’ may be required to fix the issue with regard to the conveyor belt. The global performance system may transform the task to be compatible with the facility management system of warehouse ‘A’ and then issue the task to personnel ‘X’ of warehouse ‘A’. In one example, on executing the task, the global supply chain management system may receive a status update from the warehouse A. The global supply chain management system may reanalyze the performance metrics obtained from warehouse A and warehouse B to determine a second global performance metric. The second global performance metric may be provided to the director. In one example, the director may be able to monitor whether the actionable event issued has a positive effect on the performance of the global supply chain or not. Accordingly, the director can plan a future course of action.

As techniques of the present subject matter facilitate an interaction between the user and a personnel to whom the actionable event is issued, an impact of the actionable event being executed can be monitored, based on which the global performance metrics may be reanalyzed for further action. Further, since techniques of the present subject matter transform data to overcome the problems associated with data integration, managing the supply chain at a global level by delivering desired results with optimal use of resources.

Therefore, as users associated with the decision-making process can not only view all key performance indicators of each facility of the supply chain but can also issue and monitor a progress of the actionable events to personnel at different hierarchical positions of the organization in a centralized manner, techniques of the present subject matter assist in enhancing the performance of the supply chain globally.

FIG. 5 illustrates an example of a work order being issued in accordance with an example implementation of the present subject matter. In one example, from the first global performance metric provided to the user 502, the user 502 may identify one or more actionable events. On identifying the one or more actionable events, a direction, for example a work order, may be issued to the one or more facilities of the plurality of facilities 504-1, 504-2, 504-3, . . . 504-n, alternatively and collectively referred to as plurality of facilities 504 or facility 504 of the supply chain network 503. Although the following description has been explained with respect to a work order, similar principles may be applicable to issuing a notification, assigning of a task to personnel on the work floor, issuing a new work order, reallocating work orders, and the like.

In one example, the work order may be input to the global supply chain management system 106 by the user manually. In another example, the work order may be generated by the global supply chain management system 106. For example, the user may identify that a compression pump valve of facility ‘B’ requires repair. Accordingly, the user 502 may request the global supply chain management system 106 to issue a work order to a specific personnel of the facility ‘B’ to address the issue. In one example, the work order may be created to fix the compression pump valve of facility ‘B’.

On receiving the actionable event from the user 502, the global supply chain management system 106 may store the actionable event, and gather all data associated with the actionable event. In one example, the input module 410 of the global supply chain management system 106 may receive the actionable event. In one example, the input module 410 may include a messaging service, for example, but not limited to an Azure Service Bus, to publish the actionable event.

Further, on publishing the actionable event, the analyzing module 414 of the global supply chain management system 106 may transform the actionable event to be compatible with a facility management system of a facility 504 associated with the actionable event. For example, but not limited to, the facility management systems of the plurality of facilities 504 may be different from one another, such as IRIS, SAP, field services, or any other system. In one example, based on the facility management system of the facility 504 to which the actionable event is to be issued, the analyzing module 414 may look for a transforming template to transform the actionable event. In one example, the transforming template may be used to translate the work order to a format compatible with the facility associated with the work order. Although the present subject matter discussed data transformations with the help of lookup tables, other methods of data transformation may be applicable to the principles of the present subject matter.

In one example, the data associated with the actionable event that is published may include a unique identification ID, such as a customer ID, a facility ID, an event ID, and the like: the Uniform Resource Locators (URLs) information of the facility management system to which the actionable event is to be issued, or connection mechanisms, or the version of software being utilized by the concerned facility management system, and the like. Based on this data, the transforming template may be chosen from a pre-determined lookup table 506. In one example, the pre-determined look up table 506 may be encrypted for higher levels of security. The pre-determined look up tables 506 may be stored in the memory 404 of the global supply chain management system 106. In another example, the predetermined lookup table 506 may be stored in a memory external to the global supply chain management system 106 and may be accessible to the global supply chain management system 106.

In one example, the pre-determined look up table 506 may be dynamically updated when any of the facility management systems of a particular facility is updated. This makes the global supply chain management system 106 dynamic in nature and adaptable to scale up in case a greater number of facilities are integrated into the supply chain network. Further, once the facility management system of a particular facility 504 receives the work order, the facility management system creates an external ID, which may be communicated back to global supply chain management system 106 such that a one-to-one connection may be established.

Further, the analyzing module 414 of the global supply chain management system 106 may monitor a status of the work order being executed, through the external ID provided by the facility management system of the concerned facility 504. In one example, the status update may include details regarding whether the work associated with the work order has started, whether the work has been completed, a due date of the work order, and the like. In one example, the status update may be obtained periodically, like for example every four hours, or the status update may be obtained as and when the user at the global level may want to monitor the status. In one example, the status update may be provided by a personnel of the facility associated with the work order. In another example, the status update may be automatically updated based on the data obtained from the facility 504, such as sensor data, for example.

Further, as discussed above with regard to FIG. 4, based on the status update, the analyzing module 414 may reanalyze the performance metrics obtained from the plurality of facilities to generate the second global performance metric. In one example, the second global performance metric may be provided to the user for further analysis. Therefore, as techniques of the present subject matter facilitate the issuance of an actionable event which is compatible to the facility management system by transforming the data to be compatible with the facility management system associated with the actionable event, the present subject matter improves the efficiency in integration of data and also improves the efficiency in management of facilities at a global level by scaling up the data integration between the plurality of facilities of the global supply chain network.

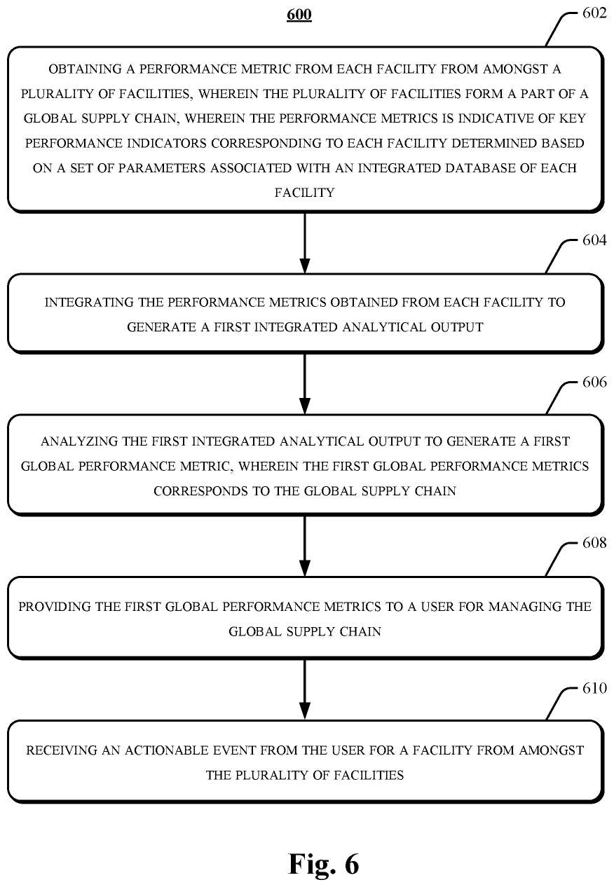

FIG. 6 illustrates a method 600 for global supply chain management, in accordance with an example implementation of the present subject matter. The order in which the method 600 is described is not intended to be construed as a limitation, and any number of the described method blocks can be combined in any order to implement method 600 or an alternative method. Additionally, individual blocks may be deleted from the method 600 without departing from the spirit and scope of the subject matter described herein. Furthermore, the method 600 may be implemented in any suitable hardware, computer readable instructions, firmware, or combination thereof. For discussion, the method 600 is described with reference to the implementations illustrated in FIGS. 1-5.

At block 602, the method 600 includes obtaining a performance metric from each facility from amongst a plurality of facilities, where the plurality of facilities form a part of a global supply chain. The performance metrics is indicative of key performance indicators corresponding to each facility determined based on a set of parameters associated with an integrated database of each facility. In one example, the integrated database may include data collected from one or more sub-systems associated to each facility of the plurality of facilities. For example, but not limited to, the sub-systems may be a workforce intelligence system, an asset performance management system, a yard management system, an inventory management system, an operation management system, a warehouse execution system, a control system database, an energy sustainability system, a labour management system, and the like.

At block 604, the method 600 includes integrating the performance metrics obtained from each facility to generate a first integrated analytical output and on integrating the performance metrics, at block 606, the method 600 includes analyzing the first integrated analytical output to generate a first global performance metric. In one example, the first global performance metric may correspond to the global supply chain. In one example, analyzing the first integrated analytical output may include performing a comparative analysis of the performance metric obtained from each facility, amongst the plurality of facilities.

Further, a recommended action based on the first global performance metric may be generated, where the recommended action may be provided to the user. Additionally, the first global performance metric may be filtered based on a key performance indicator, a location of a facility, and a time window, in reponse to a request received from the user.

At block 608, the method 600 includes providing the first global performance metrics to a user for managing the global supply chain. In one example, the user may monitor the first global performance metrics to understand the various issues associated with each facility from amongst the plurality of facilities. Based on the first global performance metrics provided, the user may identify an actionable event to be issued to one or more personnel of one or more facilities.

At block 610, the method 600 includes receiving an actionable event from the user for a facility from amongst the plurality of facilities. In one example, the actionable event may be issued to a personnel associated with the actionable event directly. In another example, the actionable event may be issued to the facility associated with the actionable event. In one example, the actionable events may be identified to optimize the key performance indicators corresponding to each facility, at a global level.

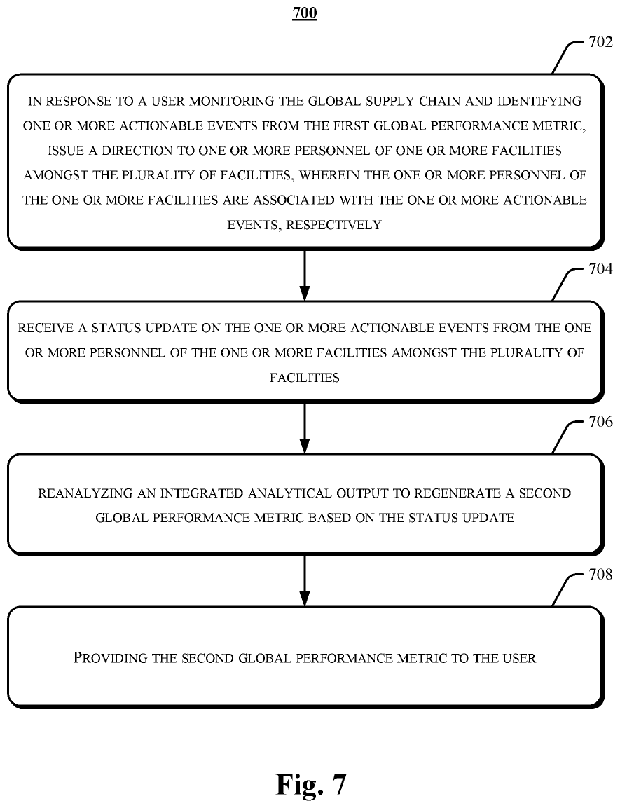

FIG. 7 illustrates another method 700 for global supply chain management, in accordance with an embodiment of the present subject matter. The order in which the method 700 is described is not intended to be construed as a limitation, and any number of the described method blocks can be combined in any order to implement method 700 or an alternative method. Additionally, individual blocks may be deleted from the method 700 without departing from the spirit and scope of the subject matter described herein. Furthermore, the method 700 may be implemented in any suitable hardware, computer readable instructions, firmware, or combination thereof. For discussion, the method 700 is described with reference to the implementations illustrated in FIGS. 1-5.

At block 702, the method 700 includes receiving a direction to be issued, where the direction may be issued to one or more personnel of one or more facilities from amongst the plurality of facilities, where the one or more personnel of the one or more facilities are associated with the one or more actionable events, respectively. In one example, the actionable event may be transformed into a format compatible with the one or more facility management systems of the one or more facilities associated with the one or more actionable events, respectively. In one example, the actionable event may include issuing a notification, assigning of a work order based on an identified issue, issuing a new work order, and reallocating work orders.

At block 704, the method 700 includes receiving a status update on the one or more actionable events from the one or more personnel of the one or more facilities amongst the plurality of facilities.

At block 706, the method 700 includes reanalyzing an integrated analytical output to regenerate a second global performance metric based on the status update received from the one or more facilities.

At block 708, the method 700 includes providing the second global performance metric to the user. In one example, the user may monitor the second global performance metric to plan a future course of action for the global supply chain.

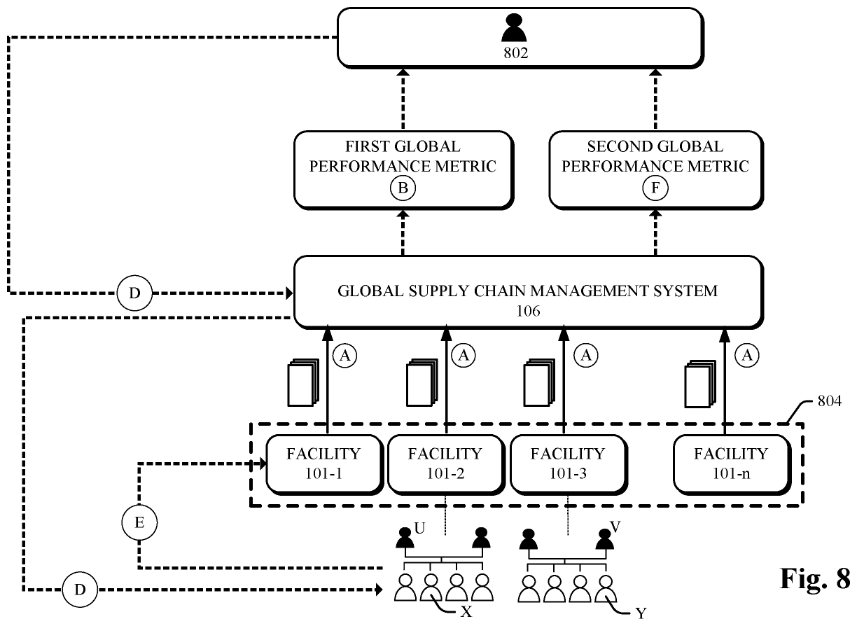

FIG. 8 illustrates an example of a global supply chain management scenario corresponding to monitoring energy sustainability, in accordance with an example implementation of the present subject matter. The present subject matter will now be illustrated with a working example, which is intended to illustrate the working of disclosure and not intended to be taken restrictively to imply any limitations on the scope of the present disclosure. Unless defined otherwise, all technical and scientific terms used herein have the same meaning as commonly understood to one of ordinary skill in the art to which this disclosure belongs. It is to be understood that this disclosure is not limited to the particular methods and experimental conditions described, as such methods and conditions may vary depending on the process and inputs used as will be easily understood by a person skilled in the art.

In one example, the global supply chain management system 106 may obtain a performance metric ‘A’ from each of the plurality of facilities 101-1, 101-2, 101-3, . . . , 101-n. In one example, the plurality of facilities may be located at different geographical locations. For example, a first facility 101-1 of the plurality of facilities may be located in Texas, a second facility 101-2 of the plurality of facilities may be located in France, and a third facility 101-3 of the plurality of facilities may be located in Denver. Each of the performance metric ‘A’ obtained from the first facility 101-1, the second facility 101-2, and the third facility 101-3, may include amongst other key performance indicators, data related to energy consumption of the assets associated with the first facility 101-1, the second facility 101-2, and the third facility 101-3, respectively.

The global supply chain management system 106, may integrate the data obtained from the first facility 101-1, the second facility 101-2, and the third facility 101-3 to generate a first integrated analytical output. Further, the global supply chain management system 106 may analyze the first integrated analytical output based on the methods discussed above to generate a first global performance metric ‘B’. In one example, the first global performance metric ‘B’ may indicate the energy consumption of the assets associated with the first facility 101-1, the second facility 101-2, and the third facility 101-3. In one example, the first global performance metric ‘B’ may indicate a comparative analysis of the energy consumption of different assets amongst the plurality of facilities, historical data of energy consumption in the first facility 101-1, the second facility 101-2, and the third facility 101-3. Further, the first global performance metric ‘B’ may also provide a recommended action. In one example, the recommended action may indicate that if asset ‘X’ in the second facility 101-2 is upgraded, the overall energy consumption of the second facility 101-2 may be reduced by 5%, which in turn would result in an increase in an efficiency of energy sustainability at a global level.

In one example, the first global performance metric ‘B’ may be provided to a group of users who form the highest layer of the hierarchical structure of an organization. The group of users who form the highest layer of the hierarchical structure of an organization may be involved in the decision-making process for the supply chain network, at a global level. In one example, a sustainability director 802 of the global supply chain may monitor the first performance metric ‘B’.

In one example, the sustainability director 802 may monitor the first global performance metric ‘B’ generated for the global supply chain 804. In another example, the sustainability director 802 may request the global supply chain management system 106 to filter the global performance metric B based on a key performance indicator, a location of a facility, and a time window. For example, the sustainability director 802 may request the global supply chain management system 106 to filter the global performance metric B based on energy consumption, for the first quarter, for example, and for facilities located at three specific locations amongst the plurality of facilities of the global supply chain 804. For example, the sustainability director 802 may request data associated with the first facility 101-1 located in Texas, the second facility 101-2 located in France, and the third facility 101-3 located in Denver.

In one example, the sustainability director 802 may identify how the energy consumption across the first facility 101-1, the second facility 101-2, and the third facility 101-3 looks like. In one example, the sustainability director 802 may identify that the energy consumption in the second facility 101-2 and the third facility is 101-3 is considerably higher than the first facility 101-1. Accordingly, may issue a direction to the global supply chain system 106, to issue an actionable event ‘D’ to the personnel concerned with the asset in the second facility 101-2, and the third facility 101-3, respectively. In one example, the actionable event ‘D’ may be a work order. The work order ‘D’ may be transformed to be compatible to a facility management system of the facility 101-2 and a facility management system of facility 101-3, respectively. In one example, the work order ‘D’ may be directly issued to personnel ‘X’ of the second-facility 101-2 and a personnel ‘Y’ of the third facility 101-3, by the global supply chain management system 106 by the way of a notification, a message, an e-mail, and the like. In one example, the work order ‘D’ may be issued to a reporting authority U and reporting authority V of facility 101-2 and facility 101-3, in addition to personnel ‘X’ and personnel ‘Y’ of facility 101-2 and facility 101-3, respectively.

In one example, personnel ‘X’ may execute the work order issued associated with the asset of the second facility 101-2 and may update a status ‘E’ of the work order being executed. In another example, the reporting authority ‘U’ of the second facility 101-2 may update the status ‘E’. Similarly, personnel ‘Y’ may execute the work order issued associated with the asset of the third facility 101-3 and may update a status ‘E’ of the work order being executed. In another example, the reporting authority ‘V’ of the third facility 101-3 may update the status ‘E’. In yet another example, the status update ‘E’ may be obtained from the assets of the second facility 101-2 and the third facility 101-3, directly. For example, updates ‘E’ may be received from sensors associated with the concerned assets of the second facility 101-2 and the third facility 101-3, respectively.

Based on the status update ‘E’ obtained from the second facility 101-2 and the third facility 101-3, the global supply chain management system 106 may reanalyze the performance metric obtained from the second facility 101-2 and the third facility 101-3, to generate a second global performance metric ‘F’. The second global performance metric ‘F’ may be provided to the sustainability director 802 to monitor an effect of the work orders issued, and to plan a further course of action. In one example, if it is observed that the execution of the work orders issued resulted in a decrease of the overall energy consumption of the supply chain, similar work orders may be issued across various other facilities to achieve a significant decrease in the energy consumption, at a global level. In another example, if it is observed that execution of the work orders do not bring about a significant change in the energy consumption levels, another work order to address the issue through another approach may be issued.

Therefore, as the sustainability director can not only view all key performance indicators of each facility of the supply chain but can also issue and monitor a progress of the actionable events to personnel at different hierarchical positions of the organization in a centralized manner, techniques of the present subject matter assist in enhancing the performance of the supply chain globally. Furthermore, since techniques of the present subject matter transform data to overcome the problems associated with data integration, managing the supply chain at a global level is further enhanced by delivering desired results with optimal use of resources.

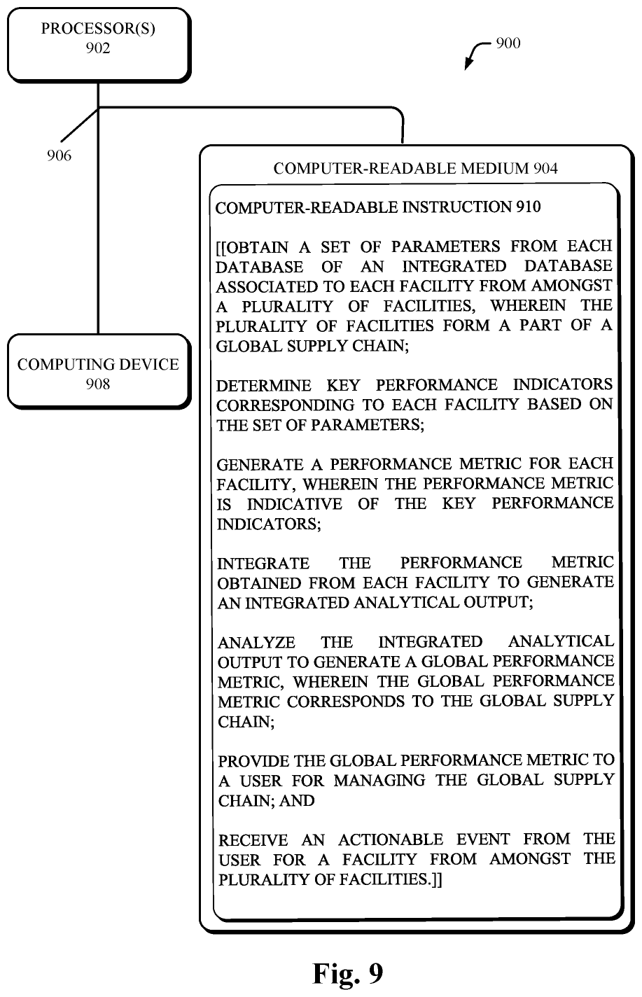

FIG. 9 illustrates a non-transitory computer-readable medium for global supply chain management, in accordance with an example of the present subject matter. In an example, the computing environment 900 includes processor 902 communicatively coupled to a non-transitory computer readable medium 904 through communication link 906. In an example implementation, the computing environment 900 may be for example, the global supply chain management system 106. In an example, the processor 902 may have one or more processing resources for fetching and executing computer-readable instructions from the non-transitory computer readable medium 904. The processor 902 and the non-transitory computer readable medium 904 may be implemented, for example, in the global supply chain management system 106.

The non-transitory computer readable medium 904 may be, for example, an internal memory device or an external memory. In an example implementation, the communication link 906 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 904 includes a set of computer readable instructions 910 which may be accessed by the processor 902 through the communication link 906 and subsequently executed for global supply chain management. The processor(s) 902 and the non-transitory computer readable medium 904 may also be communicatively coupled to a computing device 908 over the network.

Referring to FIG. 9, in an example, the non-transitory computer readable medium 904 includes computer readable instructions 910 that cause the processor 902 to obtain a set of parameters from each database of an integrated database associated to each facility from amongst a plurality of facilities, where the plurality of facilities form a part of a global supply chain.

The instructions 910 may further cause the processor 902 to determine key performance indicators corresponding to each facility based on the set of parameters and generate a performance metric for each facility, where the performance metric is indicative of the key performance indicators.

Further, the instructions 910 may cause the processor 902 to integrate the performance metric obtained from each facility to generate an integrated analytical output, analyze the integrated analytical output to generate a global performance metric, where the global performance metric corresponds to the global supply chain.

The instructions 910 may further cause the processor 902 to provide the global performance metric to a user for managing the global supply chain and receive an actionable event from the user for a facility from amongst the plurality of facilities.

Although examples of the present subject matter have been described in language specific to methods and/or structural features, it is to be understood that the present subject matter is not limited to the specific methods or features described. Rather, the methods and specific features are disclosed and explained as examples of the present subject matter.

I/we claim:

1. A method for global supply chain management, the method comprising:
obtaining a performance metric from each facility from amongst a plurality of facilities, wherein the plurality of facilities form a part of a global supply chain, wherein the performance metric is indicative of key performance indicators corresponding to each facility determined based on a set of parameters associated with an integrated database of each facility;
integrating the performance metric obtained from each facility to generate a first integrated analytical output;
analyzing the first integrated analytical output to generate a first global performance metric, wherein the first global performance metric corresponds to the global supply chain;
providing the first global performance metric to a user for managing the global supply chain; and
receiving an actionable event from the user for a facility from amongst the plurality of facilities.

2. The method as claimed in claim 1 comprises transforming the actionable event into a format compatible with a facility management system of the facility associated with the actionable event.

3. The method as claimed in claim 1 comprises issuing the actionable event to a personnel of the facility, wherein the personnel of the facility is associated with the actionable event.

4. The method as claimed in claim 3 comprises receiving a status update on the actionable event from the personnel of the facility.

5. The method as claimed in claim 4 comprises reanalyzing a second integrated analytical output to regenerate a second global performance metric based on the status update.

6. The method as claimed in claim 1 comprises generating a recommended action based on the first global performance metric and providing the recommended action to the user.

7. The method as claimed in claim 1, wherein analyzing the first integrated analytical output includes performing a comparative analysis of the performance metric obtained from each facility, amongst the plurality of facilities.

8. The method as claimed in claim 1, wherein the plurality of facilities are located at different geographical locations.

9. The method as claimed in claim 1 comprises filtering the first global performance metric based on a key performance indicator, a location of a facility, and a time window, in reponse to a request received from the user.

10. The method as claimed in claim 1, wherein the integrated database includes data collected from a plurality of sub-systems associated with each facility, wherein the plurality of sub-systems include workforce intelligence system, an asset performance management system, a yard management system, an inventory management system, an operation management system, a warehouse execution system, a control system, an energy sustainability system, and a labour management system.

11. The method as claimed in claim 1, wherein the actionable event includes issuing a notification, assigning of a work order based on an identified issue, issuing a new work order, and reallocating work orders.

12. A system for global supply chain management, the system comprising:
an input module to
obtain a performance metric from each facility from amongst a plurality of facilities, wherein the plurality of facilities form a part of a global supply chain, wherein the performance metric is indicative of key performance indicators corresponding to each facility determined based on a set of parameters associated with an integrated database of each facility:
an integrating module to
integrate the performance metric obtained from each facility to generate a first integrated analytical output:
an analyzing module to
analyze the first integrated analytical output to generate a first global performance metric, wherein the first global performance metric corresponds to the global supply chain: and
an output module to
provide the first global performance metric to a user for monitoring the global supply chain and identifying one or more actionable events; and
in response to identifying one or more actionable events, receive a direction based on the identified one or more actionable events.

13. The system as claimed in claim 12, wherein the analyzing module is to transform the one or more actionable events to a format compatible with a facility management system of one or more facilities amongst the plurality of facilities, respectively.

14. The system as claimed in claim 12, wherein the output module is to issue the direction based on the identified one or more actionable events to one or more personnel of one or more facilities amongst the plurality of facilities, wherein the one or more personnel of the one or more facilities are associated with the one or more actionable events, respectively.

15. The system as claimed in claim 12, wherein the input module is to receive a status update on the one or more actionable events from the one or more personnel of the one or more facilities amongst the plurality of facilities, respectively.

16. The system as claimed in claim 12, wherein the analyzing module reanalyzes a second integrated analytical output to regenerate a second global performance metric based on a status update received from the one or more personnel of the one or more facilities.

17. The system as claimed in claim 12, wherein the analyzing module is to generate a recommended action based on the first global performance metric and provide the recommended action to the user.

18. The system as claimed in claim 12, wherein the one or more actionable events are identified to optimize the key performance indicators corresponding to each facility, at a global level.

19. A non-transitory computer-readable medium comprising instructions for global supply chain management, the instructions being executable by a processor to:
obtain a set of parameters from each database of an integrated database associated to each facility from amongst a plurality of facilities, wherein the plurality of facilities form a part of a global supply chain:
determine key performance indicators corresponding to each facility based on the set of parameters:
generate a performance metric for each facility, wherein the performance metric is indicative of the key performance indicators;
integrate the performance metric obtained from each facility to generate an integrated analytical output;
analyze the integrated analytical output to generate a global performance metric, wherein the global performance metric corresponds to the global supply chain;
provide the global performance metric to a user for managing the global supply chain; and
receive an actionable event from the user for a facility from amongst the plurality of facilities.

20. The non-transitory computer-readable medium as claimed in claim 19, wherein the actionable event includes issuing a notification, assigning of a work order based on an identified issue, issuing a new work order, and reallocating work orders.
